(19) United States
(12) Patent Application Publication
(10) Pub. No.: US 2026/0356716 A1
(43) Pub. Date: Nov. 12, 2026

(54) WATER PURIFICATION DEVICE

(71) Applicant: Jiayu Du, Cixi (CN)

(72) Inventor: Jiayu Du, Cixi (CN)

(21) Appl. No.: 19/707,234

(22) Filed: Jun. 13, 2026

(30) Foreign Application Priority Data
May 11, 2026 (CN) 202610643031.1

(51) Int. Cl. C02F 9/00; C02F 1/00; C02F 1/32; C02F 1/44

(52) U.S. Cl. CPC C02F 9/00; C02F 1/001; C02F 1/325; C02F 1/441; C02F 1/444; C02F 2201/005; C02F 2201/007; C02F 2209/40; C02F 2301/046; C02F 2301/08

(57) ABSTRACT

Provided is a water purification device, which includes a box body. Two sets of ultrafiltration modules are provided inside the box body, and an activated carbon filtration module is provided on sides of the ultrafiltration modules inside the box body. A first reverse osmosis membrane module and a second reverse osmosis membrane module are provided inside the box body, and a constant pressure buffer tank is provided on one side inside the box body. A water tank is provided at a top of an inner wall of the box body, and a connection pipe and a water inlet pipe are provided at a bottom of the water tank. The water purification device can facilitate the purification of hard water by entering the interior of the box body through the water inlet pipe, and performing preliminary filtration on the hard water through the ultrafiltration modules.

### CROSS-REFERENCE TO RELATED APPLICATIONS

This application claims priority to Chinese Patent Application No. 202610643031.1, filed on May 11, 2026, which is hereby incorporated by reference in its entirety.

### TECHNICAL FIELD

The present disclosure relates to the field of purification equipment, and in particular, to a water purification device.

### BACKGROUND

Hard water purification, in simple terms, is the process of separating or decomposing pollutants in water through physical, chemical, biological and other methods to meet emission standards or recycle and reuse them. Hard water purification requires multiple steps, but the purification time is long, the cycle is long, and it occupies a large space. For some small purification equipment, when used, only large particles and impurities in the water are filtered through multiple filter cotton, and subsequent water filtration is required, resulting in low work efficiency.

### SUMMARY

Based on this, the purpose of the present disclosure is to provide a water purification device to solve the technical problems mentioned in the background technology.

To achieve the above objectives, the present disclosure provides the following technical solution: a water purification device, including: a box body, where two sets of ultrafiltration modules are provided inside the box body, and an activated carbon filtration module is provided on sides of the ultrafiltration modules inside the box body; a first reverse osmosis membrane module and a second reverse osmosis membrane module are provided inside the box body, a constant pressure buffer tank, a first booster pump, and a second booster pump are provided on one side inside the box body; a water tank is provided at a top of an inner wall of the box body, and a connection pipe and a water inlet pipe are provided at a bottom of the water tank; one end of the connection pipe is connected to the second booster pump, and a water outlet pipe is provided on one side of the second booster pump; a constant pressure buffer tank is provided at a top of the water outlet pipe; sides of the ultrafiltration modules are provided with a hard water inlet pipe, and an outer wall of the hard water inlet pipe is provided with a ball valve; sides of the ultrafiltration modules are provided with a wastewater discharge pipe and an ultrafiltration water outlet; one end of the ultrafiltration water outlet is provided with an inlet pipe, and the inlet pipe is connected to a bottom of the activated carbon filtration module; the bottom of the activated carbon filtration module is provided with an access pipe, and one end of the access pipe is provided with an installation pipe; one end of the installation pipe is connected to a bottom of the first booster pump, and a bend pipe is provided on one side of the bottom of the first booster pump; one end of the bend pipe is connected to one side of a bottom of the first reverse osmosis membrane module; and a pipeline component is provided on one side of the bottom of the first reverse osmosis membrane module. One end of a horizontal pipe is provided with a reflux pipe, and one end of the reflux pipe is connected to an access pipe.

By adopting the above technical solution, it is convenient to purify hard water. The water enters the box body through the water inlet pipe and is preliminarily filtered by the ultrafiltration modules. The filtered water enters the activated carbon filtration module for filtration. After filtration, the water is further filtered by the first reverse osmosis membrane module and the second reverse osmosis membrane module, rendering the filtered water purer. The filtered water reaches the water tank and is sterilized by the UV sterilization lamp. Then, the pure water is discharged through the second booster pump, which has better filtration effect on hard water and is more convenient to use.

In some embodiments of the present disclosure, an air filter element is provided at a top of the water tank, and an UV sterilization lamp is provided at a bottom of the water tank.

In some embodiments of the present disclosure, the UV sterilization lamp can sterilize the water in the water tank, and the air filter element can prevent impurities in the external gas from entering the water tank.

In some embodiments of the present disclosure, a flow meter is provided at the bottom of the water tank, and the flow meter is connected to one end of the water inlet pipe, and a water quality probe is provided on an outer wall of the water inlet pipe.

In some embodiments of the present disclosure, the flow meter can detect the flow rate of the liquid passing through the water inlet pipe, and the water quality probe can detect the purified water.

In some embodiments of the present disclosure, the pipeline component includes a communication pipe, a concentrated water outlet pipe, an exhaust water pipe, a horizontal pipe, and pure water pipes, one side of a bottom of the first reverse osmosis membrane module is provided with the communication pipe, and the communication pipe is connected to the bend pipe, and one side of the first reverse osmosis membrane module is provided with the concentrated water outlet pipe, and one end of the concentrated water outlet pipe is connected to one side of the second reverse osmosis membrane module, and one side of the second reverse osmosis membrane module is provided with the exhaust water pipe, and the side of the bottom of the second reverse osmosis membrane module and the side of the bottom of the first reverse osmosis membrane module are provided with the pure water pipes, and where ends of the pure water pipes are connected to the water inlet pipe.

In some embodiments of the present disclosure, water enters the interior of the first reverse osmosis membrane module through the connection pipe for further filtration. After filtration, pure water is discharged through the pure water outlet of the first reverse osmosis membrane module, pure water enters the pure water pipe, and concentrated water is discharged through the concentrated water outlet. The concentrated water enters the interior of the concentrated water outlet pipe and reaches the water inlet of the second reverse osmosis membrane module through the concentrated water outlet pipe. The water is filtered again by the second reverse osmosis membrane module, and the concentrated water inside the second reverse osmosis membrane module flows into the water outlet pipe and is discharged from the box body through the water outlet pipe. Pure water is discharged through the pure water pipe, and the pure water pipe is connected to the water inlet pipe. The pure water flowing out of the first reverse osmosis membrane module and the second reverse osmosis membrane module both reach the interior of the water tank. Providing the pipeline component can make the water pass through the first reverse osmosis membrane module and the second reverse osmosis membrane module in sequence, so as to achieve better water purification effect.

In some embodiments of the present disclosure, a first needle valve core is provided inside the exhaust water pipe, and a second needle valve core is provided inside the horizontal pipe.

In some embodiments of the present disclosure, the first needle valve core can adjust the water output of the water outlet pipe or close it, while the second needle valve core can adjust the water output of the horizontal pipe or close it.

In some embodiments of the present disclosure, a conductivity meter is provided at the other end of the installation pipe.

In some embodiments of the present disclosure, the conductivity meter is used to measure a total amount of dissolved solids in water.

In some embodiments of the present disclosure, an installation plate is provided on one side of the inner wall of the box body, and the installation plate is connected to the tops of the ultrafiltration modules, the activated carbon filtration module, the first reverse osmosis membrane module, and the second reverse osmosis membrane module.

In some embodiments of the present disclosure, the installation plate can limit the tops of the ultrafiltration module, the activated carbon filtration module, the first reverse osmosis membrane module, and the second reverse osmosis membrane module to avoid tilting during use.

In some embodiments of the present disclosure, one end of the water outlet pipe penetrates the box body, and the outer wall of the box body is provided with multiple installation holes.

In some embodiments of the present disclosure, the external pipeline is connected to the water outlet pipe to allow pure water to be discharged and avoid the problem of splashing on the ground. The installation holes are designed to facilitate the installation of hard water inlet pipes, wastewater discharge pipes, ultrafiltration water outlet pipes, outlet pipes, and horizontal pipes.

In summary, the present disclosure mainly has the following beneficial effects:
1. in the present disclosure, by providing the water tank, the ultrafiltration modules, the activated carbon filtration module, the first reverse osmosis membrane module, the second reverse osmosis membrane module, the first booster pump, and pipeline components, which can facilitate the purification of hard water; the hard water enters the interior of the box body through the water inlet pipe and is preliminarily filtered by the ultrafiltration modules; the filtered water enters the activated carbon filtration module for filtration and is further filtered by the reverse osmosis membrane module and the second reverse osmosis membrane module, rendering the filtered water more pure; the filtered water reaches the water tank and is sterilized by the UV sterilization lamp; then, the pure water is discharged through the second booster pump, which has better filtration effect on hard water and is more convenient to use.
2. in the present disclosure, by proving the first needle valve core and the second needle valve core; the first needle valve core can adjust the water output of the outlet pipe, and the second needle valve core can block the horizontal pipe to avoid the problem of liquid outflow.

### BRIEF DESCRIPTION OF DRAWINGS

FIG. 1 is a structural schematic diagram provided by the present disclosure.

FIG. 2 is a side view diagram provided by the present disclosure.

FIG. 3 is an installation schematic diagram of a water tank provided by the present disclosure.

FIG. 4 is an installation schematic diagram of a second reverse osmosis membrane module provided by the present disclosure.

FIG. 5 is an installation schematic diagram of a connection pipe provided by the present disclosure.

FIG. 6 is a connection schematic diagram of a first reverse osmosis membrane module provided by the present disclosure.

FIG. 7 is a sectional view of a horizontal pipe provided by the present disclosure.

FIG. 8 is a partial sectional view of the second reverse osmosis membrane module of the present disclosure.

Numeral reference: 1—box body, 2—cabinet door, 3—water tank, 31—air filter element, 32—UV sterilization lamp, 4—ultrafiltration module, 41—activated carbon filtration module, 5—first reverse osmosis membrane module, 6—second reverse osmosis membrane module, 7—constant pressure buffer tank, 71—water outlet pipe, 8—first booster pump, 9—second booster pump, 10—connection pipe, 11—water inlet pipe, 12—water quality probe, 13—hard water inlet pipe, 14—wastewater discharge pipe, 15—ultrafiltration water outlet, 16—flow meter, 17—ball valve, 18—reflux pipe, 19—installation pipe, 20—bend pipe, 21—concentrated water outlet pipe, 22—exhaust water pipe, 23—horizontal pipe, 24—first needle valve core, 25—second needle valve core, 26—communication pipe, 27—pure water pipe, 28—inlet pipe, 29—access pipe, 30-installation plate.

### DESCRIPTION OF EMBODIMENTS

Below the technical solutions in the embodiments of the present disclosure will be clearly and completely described in combination with the accompanying drawings. The embodiments described below with reference to the accompanying drawings are exemplary and are only used to explain the present disclosure, and should not be construed as limiting the present disclosure.

Below, the embodiments of the present disclosure will be described based on its overall structure.

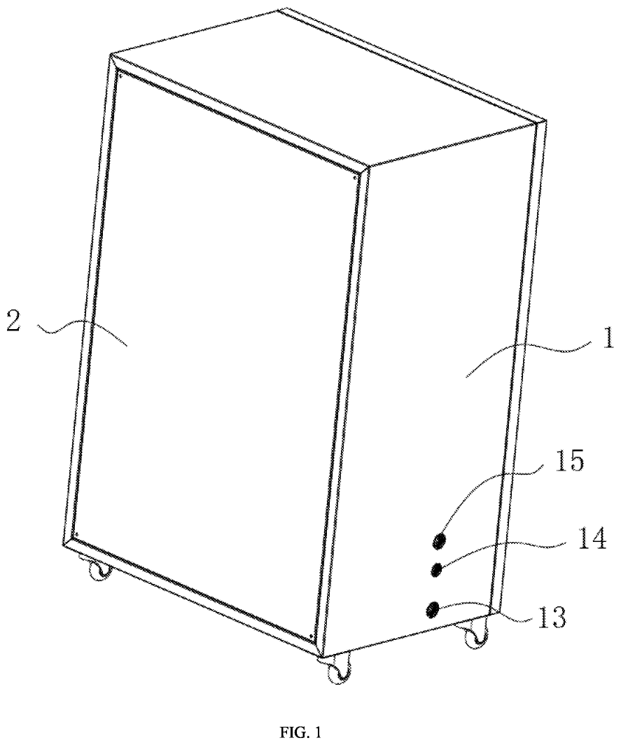

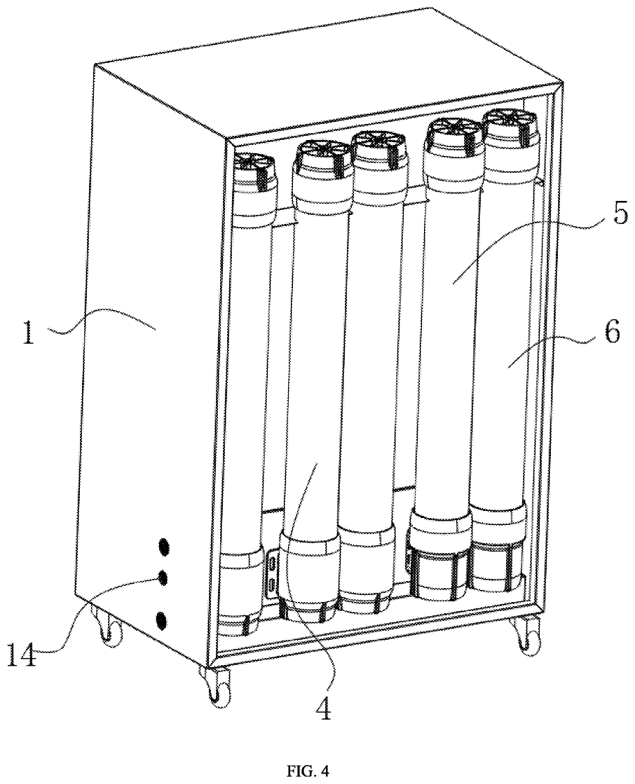

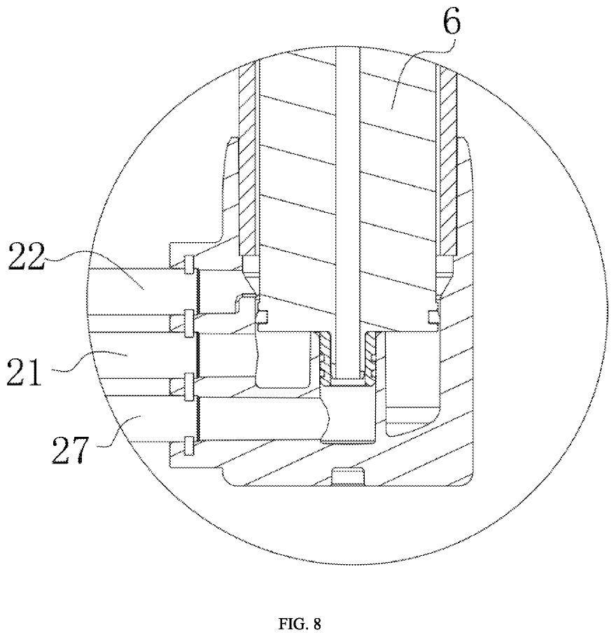

Referring to FIGS. 1-8, a water purification device includes a box body 1. There are two sets of ultrafiltration modules 4 provided inside the box body 1, and an activated carbon filtration module 41 is provided on one side of the ultrafiltration modules 4 and inside the box body 1. A first reverse osmosis membrane module 5 and a second reverse osmosis membrane module 6 are provided inside the box body 1, and a constant pressure buffer tank 7, a first booster pump 8, and a second booster pump 9 are provided on one side inside the box body 1. A top of an inner wall of the box body 1 is provided with a water tank 3, and a bottom of the water tank 3 is provided with a connection pipe 10 and a water inlet pipe 11. One end of the connection pipe 10 is connected to the second booster pump 9, and one side of the second booster pump 9 is provided with a water outlet pipe 71. A top of the water outlet pipe 71 is provided with the constant pressure buffer tank 7. Sides of the ultrafiltration modules 4 are provided with a hard water inlet pipe 13, and an outer wall of the hard water inlet pipe 13 is provided with a ball valve 17. Sides of the ultrafiltration modules 4 are provided with a wastewater discharge pipe 14 and an ultrafiltration water outlet 15. One end of the ultrafiltration water outlet 15 is provided with an inlet pipe 28, and the inlet pipe 28 is connected to a bottom of the activated carbon filtration module 41. The bottom of the activated carbon filtration module 41 is provided with an access pipe 29, and an end of the access pipe 29 is provided with an installation pipe 19. One end of the installation pipe 19 is connected to a bottom of the first booster pump 8, and a bend pipe 20 is provided on one side of a bottom of the first booster pump 8. An end of the bend pipe 20 is connected to one side of a bottom of the first reverse osmosis membrane module 5, and a pipeline component is provided on one side of the bottom of the first reverse osmosis membrane module 5. One end of the horizontal pipe 23 is provided with a reflux pipe 18, and one end of the reflux pipe 18 is connected to the access pipe 29.

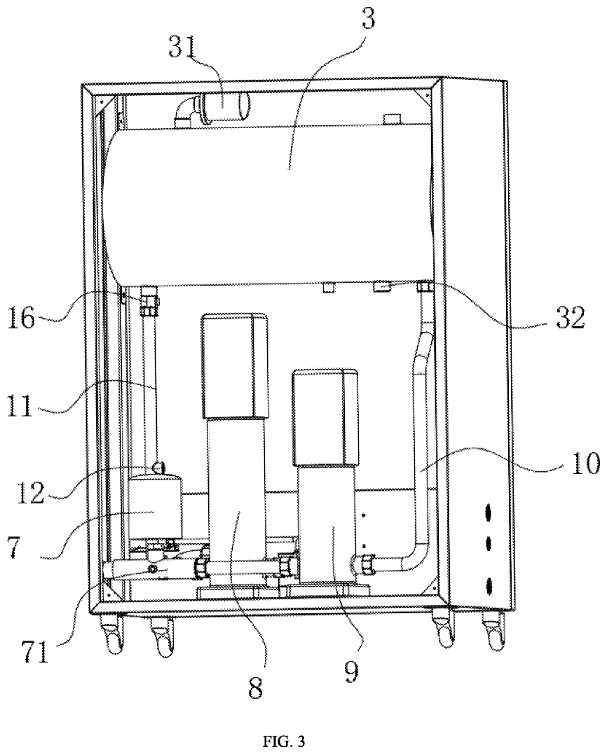

In the above embodiment, referring to FIG. 3 again for details. A top of the water tank 3 is provided with an air filter element 31, and the bottom of the water tank 3 is provided with an UV sterilization lamp 32. The UV sterilization lamp 32 can sterilize the water in the water tank, and the air filter element 31 can prevent impurities in the external gas from entering the water tank.

In the above embodiment, referring to FIG. 3 again for details. A flow meter 16 is provided at the bottom of the water tank 3, and the flow meter 16 is connected to one end of the water inlet pipe 11. A water quality probe 12 is provided on an outer wall of the water inlet pipe 11. The flow meter 16 can detect the flow rate of the liquid passing through the water inlet pipe 11, and the water quality probe 12 can detect the purified water.

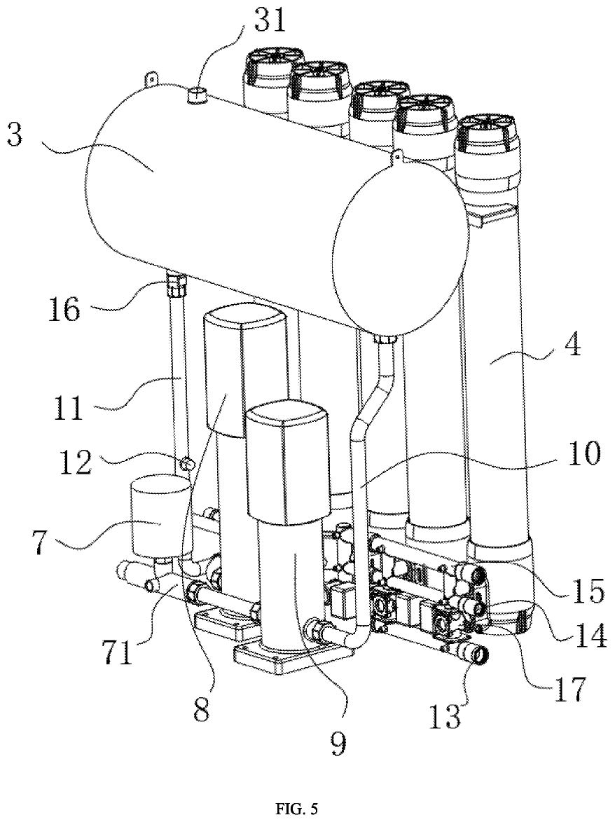

In the above embodiments, referring to FIGS. 5-7 for details. The pipeline component includes a communication pipe 26, a concentrated water outlet pipe 21, an exhaust water pipe 22, a horizontal pipe 23, and pure water pipes 27. One side of the bottom of the first reverse osmosis membrane module 5 is provided with the communication pipe 26, and the communication pipe 26 is connected to the bend pipe 20. One side of the first reverse osmosis membrane module 5 is provided with the concentrated water outlet pipe 21, and one end of the concentrated water outlet pipe 21 is connected to one side of the second reverse osmosis membrane module 6. One side of the second reverse osmosis membrane module 6 is provided with the exhaust water pipe 22, and one side of a bottom of the second reverse osmosis membrane module 6 and one side of the bottom of the first reverse osmosis membrane module 5 have the pure water pipes 27. The two sets of pure water pipes 27 are connected, and ends of the pure water pipes 27 are connected to the water inlet pipe 11, and water enters an interior of the first reverse osmosis membrane module 5 through the communication pipe 26 for further filtration. After filtration, pure water is discharged through the pure water outlet of the first reverse osmosis membrane module 5, pure water enters the pure water pipes 27, and concentrated water is discharged through a concentrated water outlet. The concentrated water enters the interior of the concentrated water outlet pipe 21 and reaches a water inlet of the second reverse osmosis membrane module 6 through the concentrated water outlet pipe 21. The water is filtered again by the second reverse osmosis membrane module 6. The concentrated water inside the second reverse osmosis membrane module 6 flows into the exhaust water pipe 22 and is discharged from the box body 1 through the exhaust water pipe 22. Pure water is discharged through the pure water pipes 27, and the pure water pipes 27 are connected to the water inlet pipe 11. The pure water flowing out of the first reverse osmosis membrane module 5 and the second reverse osmosis membrane module 6 reaches the interior of the water tank 3. Providing the pipeline component can make the water pass through the first reverse osmosis membrane module 5 and the second reverse osmosis membrane module 6 in sequence, thereby achieving the better effect of water purification.

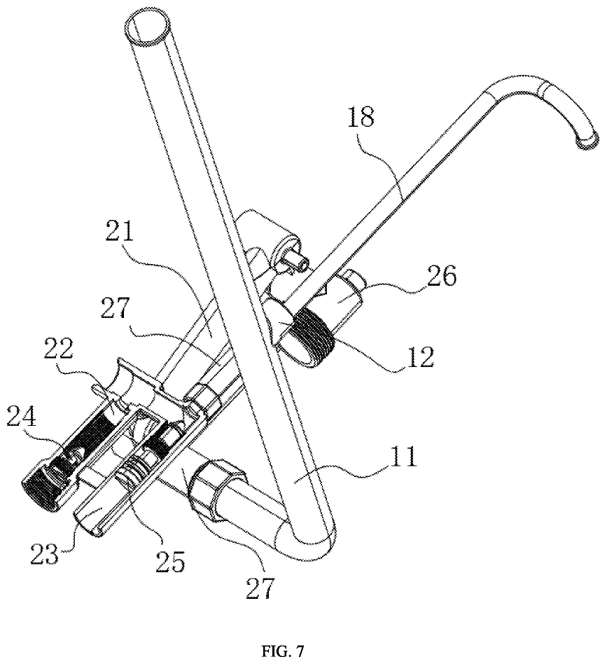

In the above embodiment, referring to FIG. 7 again for details. The first needle valve core 24 is provided inside the exhaust water pipe 22, and the second needle valve core 25 is provided inside the horizontal pipe 23. A tail end of the first needle valve core 24 is hollow, and a water output of the exhaust water pipe 22 can be adjusted by setting the first needle valve core 24. The second needle valve core 25 is also arranged, and the second needle valve core 25 can block the inside of the horizontal pipe 23 to avoid the problem of liquid outflow.

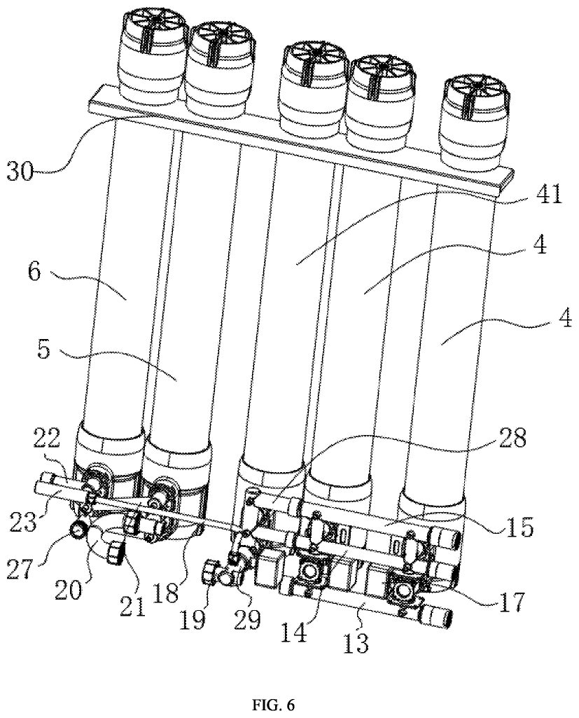

In the above embodiment, referring to FIG. 6 again for details. The other end of the installation tube 19 is provided with a conductivity meter, and the conductivity meter is used to measure a total amount of dissolved solids in water.

In the above embodiment, referring to FIG. 6 again for details. One side of an inner wall of the box body 1 is provided with an installation plate 30, and the installation plate 30 is connected to tops of the ultrafiltration modules 4, the activated carbon filtration module 41, the first reverse osmosis membrane module 5, and the second reverse osmosis membrane module 6. The installation plate 30 can limit the tops of the ultrafiltration modules 4, the activated carbon filtration module 41, the first reverse osmosis membrane module 5, and the second reverse osmosis membrane module 6 to avoid tilting during use.

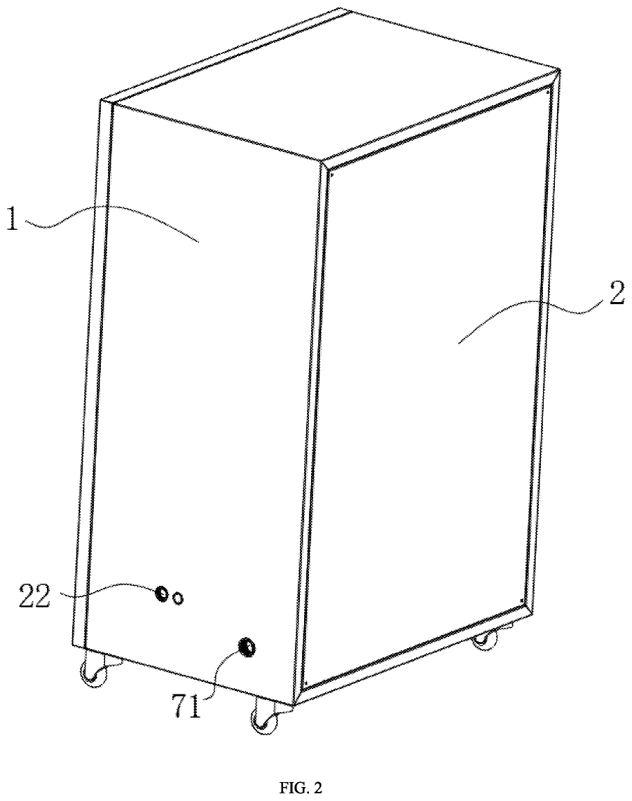

In the above embodiment, referring to FIG. 1 and FIG. 2 again for details. One end of the water outlet pipe 71 penetrates the box body 1, and an outer wall of the box body 1 is provided with multiple installation holes to connect the external pipeline with the water outlet pipe 71, so that pure water can be discharged to avoid the problem of splashing on the ground. The installation holes are arranged to facilitate the installation of the hard water inlet pipe 13, the wastewater discharge pipe 14, the ultrafiltration water outlet 15, the exhaust water pipe 22, and the horizontal pipe.

In the specific operation of the present disclosure, hard water enters the box body 1 through the hard water inlet pipe 13 during use, and then enters the interior of the set of ultrafiltration modules 4 through the hard water inlet pipe 13. Two sets of ball valves 17 are opened and closed one by one, so that sewage enters the ultrafiltration modules 4 for initial filtration. The filtered water flows out through the water outlets of the ultrafiltration modules 4 and enters the interior of the ultrafiltration water outlet 15. Then, the water inside the ultrafiltration water outlet 15 enters the interior of the inlet pipe 28 and enters the interior of the activated carbon filtration module 41 through the inlet pipe 28 to filter small impurities (organic matter, pigments, odors, heavy metals, etc.) in the water. The filtered water flows out through the water outlet of the activated carbon filtration module 41 and enters the interior of the access pipe 29, the first booster pump 8 operates to pass the water inside the access pipe 29 through the first booster pump 8, Then, it reaches the water inlet of the first reverse osmosis membrane module 5 through the bend pipe 20, reaches the interior of the first reverse osmosis membrane module 5, and further filters the water. After filtration, the pure water is discharged through the pure water outlet of the first reverse osmosis membrane module 5, enters the pure water pipes 27, and the concentrated water is discharged through the concentrated water outlet. The concentrated water enters the interior of the concentrated water outlet pipe 21 and reaches the water inlet of the second reverse osmosis membrane module 6 through the concentrated water outlet pipe 21. The water is filtered again through the second reverse osmosis membrane module 6. The concentrated water inside the second reverse osmosis membrane module 6 flows into the exhaust water pipe 22 and is discharged from the box body 1 through the exhaust water pipe 22. The pure water is discharged through the pure water pipe 27, and the pure water pipes 27 are connected to the water inlet pipe 11. The pure water flowing out of the first reverse osmosis membrane module 5 and the second reverse osmosis membrane module 6 reaches the interior of the water tank 3 and then passes through the connection pipe 10 to reach the second booster pump 9, and then reaches the water outlet pipe 71 through the second booster pump 9, and the constant pressure buffer tank 7 buffers the pure water inside the water outlet pipe 71 before discharging it into the interior of the box body 1.

Although the embodiments of the present disclosure have been shown and described, this specific embodiment is only an explanation of the present disclosure and is not a limitation of the present disclosure. The specific features, structures, materials, or characteristics described may be combined in any one or more embodiments or examples in a suitable manner. After reading this specification, those skilled in the art may make modifications, substitutions, and variations to the embodiments as needed without departing from the principles and purposes of the present disclosure, but if they are within the scope of the claims of the present disclosure.

What is claimed is:

1. A water purification device, comprising: a box body,
wherein two sets of ultrafiltration modules are provided inside the box body, and an activated carbon filtration module is provided on sides of the ultrafiltration modules inside the box body; a first reverse osmosis membrane module and a second reverse osmosis membrane module are provided inside the box body,
a constant pressure buffer tank, a first booster pump, and a second booster pump are provided on one side inside the box body;
a water tank is provided at a top of an inner wall of the box body, and a connection pipe and a water inlet pipe are provided at a bottom of the water tank;
one end of the connection pipe is connected to the second booster pump, and a water outlet pipe is provided on one side of the second booster pump;
a constant pressure buffer tank is provided at a top of the water outlet pipe; sides of the ultrafiltration modules are provided with a hard water inlet pipe, and an outer wall of the hard water inlet pipe is provided with a ball valve;
sides of the ultrafiltration modules are provided with a wastewater discharge pipe and an ultrafiltration water outlet;
one end of the ultrafiltration water outlet is provided with an inlet pipe, and the inlet pipe is connected to a bottom of the activated carbon filtration module; the bottom of the activated carbon filtration module is provided with an access pipe, and one end of the access pipe is provided with an installation pipe;
one end of the installation pipe is connected to a bottom of the first booster pump, and a bend pipe is provided on one side of the bottom of the first booster pump;
one end of the bend pipe is connected to one side of a bottom of the first reverse osmosis membrane module; and a pipeline component is provided on one side of the bottom of the first reverse osmosis membrane module.

2. The water purification device according to claim 1, wherein an air filter element is provided at a top of the water tank, and an UV sterilization lamp is provided at a bottom of the water tank.

3. The water purification device according to claim 1, wherein a flow meter is provided at the bottom of the water tank, and the flow meter is connected to one end of the water inlet pipe, and a water quality probe is provided on an outer wall of the water inlet pipe.

4. The water purification device according to claim 1, wherein the pipeline component comprises a communication pipe, a concentrated water outlet pipe, an exhaust water pipe, a horizontal pipe, and pure water pipes,
one side of a bottom of the first reverse osmosis membrane module is provided with the communication pipe, and the communication pipe is connected to the bend pipe, and one side of the first reverse osmosis membrane module is provided with the concentrated water outlet pipe, and one end of the concentrated water outlet pipe is connected to one side of the second reverse osmosis membrane module, and one side of the second reverse osmosis membrane module is provided with the exhaust water pipe, and the side of the bottom of the second reverse osmosis membrane module and the side of the bottom of the first reverse osmosis membrane module are provided with the pure water pipes, and
wherein ends of the pure water pipes are connected to the water inlet pipe.

5. The water purification device according to claim 4, wherein a first needle valve core is provided inside the exhaust water pipe, and a second needle valve core is provided inside the horizontal pipe.

6. The water purification device according to claim 4, wherein one end of the horizontal pipe is provided with a reflux pipe, and one end of the reflux pipe is connected to the access pipe.

7. The water purification device according to claim 1, wherein a conductivity meter is provided at the other end of the installation pipe.

8. The water purification device according to claim 1, wherein an installation plate is provided on one side of the inner wall of the box body, and the installation plate is connected to the tops of the ultrafiltration modules, the activated carbon filtration module, the first reverse osmosis membrane module, and the second reverse osmosis membrane module.

9. The water purification device according to claim 1, wherein one end of the water outlet pipe penetrates the box body, and the outer wall of the box body is provided with multiple installation holes.
